(19) United States
(12) Patent Application Publication
(10) Pub. No.: US 2009/0284761 A1
(43) Pub. Date: Nov. 19, 2009

(54) Systems And Methods For Customized Printing And Cutting Of A Polymer Substrate

(76) Inventors: Gerold K. Shelton, Meridian, ID (US); Michael J. Shelton, Boise, ID (US); William R. Cridland, Boise, ID (US); Steven H. Taylor, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/253,140

(22) Filed: Oct. 16, 2008

Related U.S. Application Data
(60) Provisional application No. 61/054,438, filed on May 19, 2008.

(51) Int. Cl. G06F 3/00; G06F 3/12

(52) U.S. Cl. 358/1.1; 715/700

(57) ABSTRACT

A system has an interactive user interface configured to receive image and cutting pattern selections from a user, a printing device configured to print the image selection to a polymer substrate, and a cutting device configured to cut the polymer substrate according to the cutting pattern selection.

### BACKGROUND

Vinyl sheets are often cut to create customized shapes that can be made to adhere to some relatively flat surfaces, such as windows and plastic coverings, with little difficulty. In some cases, an adhesive may be used on at least one side of the vinyl to facilitate sticking the vinyl to a desired surface. However, vinyl and similar materials may naturally adhere to some surfaces electrostatically. Consequently, the physical properties of the vinyl allow the shapes to adhere to the surfaces without requiring an additional adhesive material and to be removed from the surfaces with relative ease.

One common use for custom-cut vinyl sheets is that of protective coverings for portable electronic devices, such as cellular phones, personal digital assistants (PDAs), MP3 players, and the like. Portable electronic devices are used by many people on a daily basis. Unfortunately, these electronic devices are often subject to scratches and other minor damage incidental to daily use. Custom vinyl protective coverings can be applied to the outer surfaces of such portable electronic devices, thus providing an additional layer of resilience against incidental abrasive forces.

Other uses for custom-cut shapes from vinyl sheets are common. For example, often vinyl is used to make custom lettering or logos that can be applied to windows of automobiles or businesses.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative system of customized printing and cutting of a polymer substrate according to one embodiment of principles described herein.

FIG. 2 is a perspective view of an illustrative system of customized printing and cutting of a polymer substrate according to one embodiment of principles described herein.

FIG. 3 is a block diagram of an illustrative substrate path in a system of customized printing and cutting of a polymer substrate according to one embodiment of principles described herein.

FIG. 4 is a view of an illustrative sheet of polymer substrate after undergoing customized printing and cutting operations according to one embodiment of principles described herein.

FIG. 5 is a view of an illustrative customized protective covering being applied to a personal electronic device according to one embodiment of principles described herein.

FIG. 6 is a view of an illustrative sheet of polymer substrate after undergoing customized printing and cutting operations according to one embodiment of principles described herein.

FIG. 7 is a view of an illustrative prompt to a user on a screen of an illustrative system of customized printing and cutting of a polymer substrate according to one embodiment of principles described herein.

FIG. 8 is a view of an illustrative prompt to a user on a screen of an illustrative system of customized printing and cutting of a polymer substrate according to one embodiment of principles described herein.

FIG. 9 is a view of an illustrative prompt to a user on a screen of an illustrative system of customized printing and cutting of a polymer substrate according to one embodiment of principles described herein.

FIG. 10 is a flowchart of an illustrative method of customized printing and cutting of a polymer substrate according to one embodiment of principles described herein.

Throughout the drawings, identical reference numbers designate similar, but not necessarily identical, elements.

### DETAILED DESCRIPTION

The present specification describes methods and systems in which a user can readily customize the appearance and shape of a vinyl cover or “skin” to be used on, for example, a portable electronic device, or other vinyl cut-outs for a wide variety of purposes. Such systems and methods may include a kiosk located in a retail or other facility with a user interface through which a user can control the printed appearance, shape or other features of vinyl cut-out, whether for use as a portable electronic device cover, a vehicle decal or some other purpose.

As indicated above, consumers may desire vinyl cut-out products for use as protective coverings for personal electronic devices or other applications. Such users may also desire these protective coverings with customized images, patterns, and/or colors chosen by the user of the portable electronic device, thus adding a degree of personalization to many devices with standardized appearances. The protective barrier and personalization provided by such customized vinyl protective coverings can increase the perceived value of a portable electronic device to its owner.

However, obtaining such a customized vinyl cover for a portable electronic device or other customized vinyl cut-out products may not be simple. For example, owning a custom vinyl-cutting device and a supply of un-cut vinyl is typically not cost-effective for the majority of consumers. Consequently, to obtain a desired level of personalization, some consumers may have to order the desired vinyl cut-out products from a remote location, resulting in additional time delay and expense.

To address these and other issues, the present specification discloses systems and methods for customized printing and cutting of a polymer substrate in which an interactive user interface is configured to receive image and masking selections from a user, a printing device is configured to print the image selection to the polymer substrate, and a cutting device is configured to cut the polymer substrate according to the masking selection.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems and methods for customized printing and cutting of a polymer substrate.

### Illustrative Systems

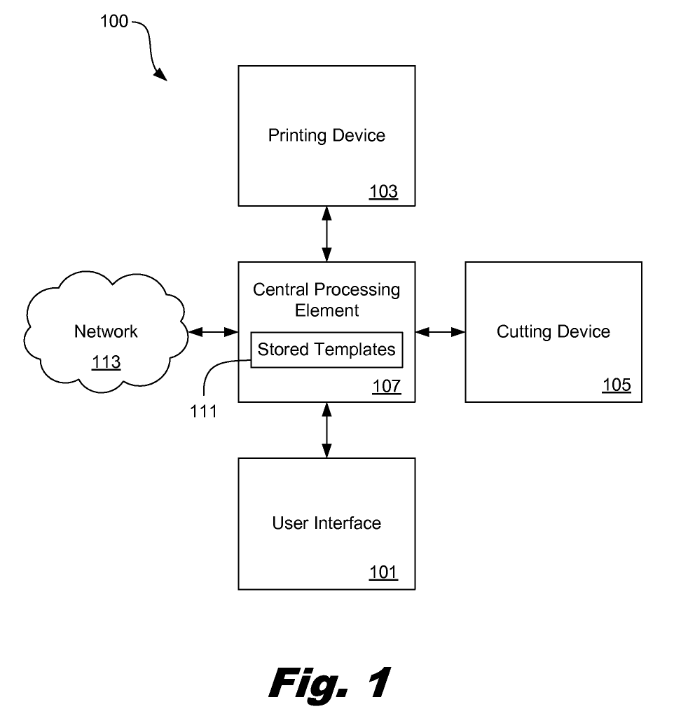

Referring now to FIG. 1, a perspective view of an illustrative system (100) for customized printing and cutting of a polymer substrate is shown. The system (100) may be used to create on-demand custom cut products from sheets of vinyl or another polymer substrate. For example, the system (100) may be used to create and sell customized protective vinyl coverings for personal electronic devices, such as cellular phones, PDAs, laptop computers, portable media players, electronic books/readers and the like.

A customer may use the desired system (100) to select a desired image to be printed on the polymer substrate and a desired cutting pattern for the substrate. The system (100) can then print the desired image on the substrate and cut the desired pattern out of the substrate. In some embodiments, the user may also be able to select a desired orientation and positioning of the image with respect to the desired cutting pattern. Additionally, the system (100) may be configured to conduct a financial transaction with the user in which payment or a promise of payment is received from the user before the printed and cut polymer product is prepared or dispensed to the user.

The system (100) may include an interactive user interface (101), a printing device (103), and a cutting device (105). Each of the user interface (101), the printing device (103), and the cutting device (105) may be in communication with a central processing element (107).

Examples of suitable central processing element (107) may include, but are not necessarily limited to: processors, microcontrollers, application-specific integrated circuits (ASICs), and the like. The central processing element (107) may be configured to execute software instructions recorded in electronic memory. The electronic memory may be internal memory of the central processing element (107), such as RAM and EEPROM, and/or external memory in communication with the central processing element (107), such as a hard drive or Flash memory.

The central processing element (107) may be configured to coordinate and/or control the operations of the user interface (101), the printing device (103), and the cutting device (105). For example, the central processing element (107) may receive data from the user through the user interface (101) that specifies a desired image and a desired cutting pattern to produce a customized vinyl cut-out. The central processing element (107) may then send data corresponding to the desired image to the printing device (103), activate the printing device (103) to print on a vinyl substrate, transport the polymer substrate through the cutting device (105) after printing operations, send data to the cutting device (105) corresponding to the desired cutting pattern, and activate the cutting device (105). The central processing element (107) may then dispense the finished product to the user and collect payment from the user.

A user may interact with the central processing element (107) through the user interface (101). The user interface (101) allows the user to provide data to the central processing element (107) through, for example, a peripheral device of the user interface (101), such as a keyboard, touchscreen, touchpad, rollerball, mouse, microphone and others. Any user input device may be used with or as part of the user interface (101). Information may also be provided to the user through one or more peripheral devices of the user interface (101), such as a display screen and/or audio speakers.

The central processing element (107) may be configured to store a plurality of templates (111). By way of example, these stored templates (111) may include stored images and stored cutting patterns. The stored images and cutting patterns can then be selectively used to produce a desired cut-out, such as a protective cover for a portable electronic device.

The stored cutting patterns may correspond to protective covering patterns for a plurality of personal electronic devices, such that a user may be able to select a pattern matching his or her personal electronic device from a list of the stored templates (111) through the user interface (101) and have a customized vinyl protective covering created for that particular personal electronic device by the system (100) on site. Additionally or alternatively, the stored cutting patterns may include letters, numbers, logos, and/or other shapes used by consumers. In certain embodiments, the stored templates (111) may undergo modification by the user through the user interface (101) before being used to create a customized polymer product for the user.

Additionally, the central processing element (107) may be connected to a network (113) such as an intranet or the Internet. The network (113) may provide the central processing element (107) access to resources that are not locally stored or available in the immediate system (100). For example, the central processing element (107) may be configured to update or expand its collection of stored images and cutting patterns (111) periodically through synchronization operations with a remote computing device, such as a server.

In certain examples, the central processing element (107) may be configured to finalize financial transactions with users through its connection to the network (113). For example, a user may be prompted to enter credit or debit account details to the central processing element (107), either by swiping a card or other identifier, or by entering the information manually. The account details received by the central processing element (107) may then be transmitted along with transaction details through the network (113) to a remote computing device, such as a credit card clearinghouse, configured to authorize or reject the transaction and make transfer available funds from the user to an account corresponding to the owner and/or purveyor of the system (100).

The printing device (103) may be configured to print the image selected by the user onto the polymer substrate. The printing device (103) may be any suitable printing device according to the needs of a particular application of the principles described herein. For example, the printing device (103) may include, but is not limited to, an inkjet printer, a laser printer, a liquid electrophotography printer, and/or a screen printer.

The cutting device (105) may be configured to receive the printed substrate from the printing device (103) and cut the substrate according to the cutting pattern selected by the user. In some embodiments, a media transport device may be disposed between an output of the printing device (103) and an input of the cutting device (105) to facilitate the feeding of the substrate from the printing device (103) to the cutting device (105).

The cutting device (105) may include any suitable polymer cutting device available, according to the needs of a particular application of the principles described herein. The cutting device (105) may include one or more blades that may be selectively manipulated on the substrate according to data received by the cutting device (105) from the central processing element (107) that corresponds to the cutting pattern selected by the user.

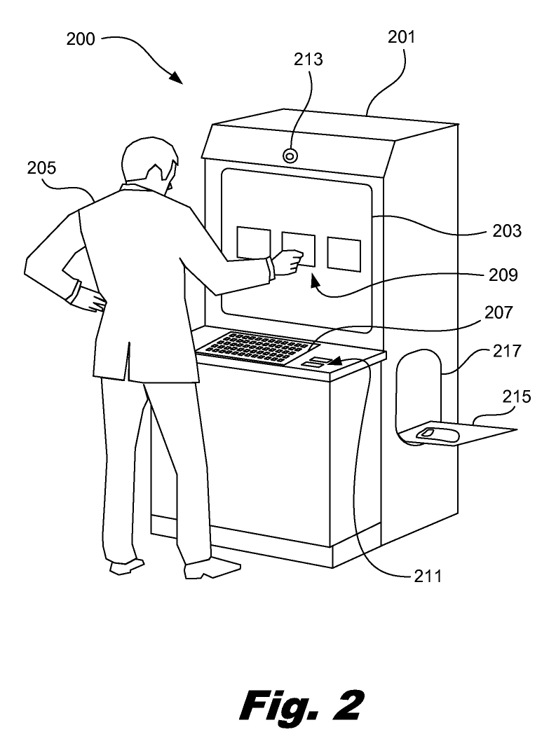

Referring now to FIG. 2, one illustrative embodiment of a system (200) for customized printing and cutting of a polymer substrate is shown. The system (200) may be placed in a public area frequented by many people, such as a mall, plaza, retail location, or similar venue. Public placement may provide people from diverse demographic groups who do not personally own customized vinyl cutting devices with easy access to the system (200) and to customized vinyl cut-outs as described herein.

In the embodiment shown, the system (200) may take the form of a kiosk (201) that has a user interface that includes a display device (203). The display device (203) may be a touch screen or similar device configured to display options and information to a user (205) from the central processing element (107, FIG. 1) while also retrieving input from the user (205) for the central processing element (107, FIG. 1). Additional input may be received from the user (205) through a keyboard (207) or other input device.

The central processing element (107, FIG. 1) of the system (200) may be configured to run software or firmware designed to provide the user (205) with interactive menus (209) through the display device (203) that guide the user (205) through the processes, for example, of selecting a desired image to be printed to the polymer substrate, selecting a cutting pattern to be applied to the substrate, masking the desired image with the cutting pattern, and paying for the printed and cut polymer cut-out.

Additionally or alternatively, the interactive menus (209) may allow the user (205) to customize images and cutting patterns to suit his or her own preferences. The user (205) may, through the user interface (101, FIG. 1) input modifications to the images or cutting patterns stored in the system (200).

In certain embodiments, the system (200) may even be configured to allow the user (205) to create or upload his or her own original images and/or cutting patterns. For example, in some embodiments the system (200) may include peripheral ports (211) into which the user may insert his or her own portable storage media (e.g. SD cards, Memory Sticks®, USB drives, other portable drives, optical disks, etc.), thereby allowing the user to upload images and/or cutting patterns stored on the media directly to the system (200) for use in creating a customized polymer cut-out product. Additionally or alternatively, the system (200) may include wireless ports (e.g. Bluetooth ports), infrared ports, and/or physical cables to provide the user (205) the option of docking a portable electronic device to the system (200) and uploading an image and/or cutting pattern directly from the portable electronic device for use in creating a customized polymer cut-out product.

In certain embodiments, the system (200) may include a camera (213) configured to capture a photographic image of one or more users (205) or some other object or event in the general vicinity of the system (200). At least a portion of the captured image may then be selected by the user (205) for printing on the polymer substrate.

After the user (205) has selected an image and cutting pattern to be used on the substrate, the system (200) may pass a vinyl substrate through the printing device (103, FIG. 1) and the cutting device (105, FIG. 1), where the desired image and cutting pattern may be applied to the substrate. A finished product (215) may then be dispensed to the user (205) at a designated output location (217). In certain embodiments, the user (205) may be required to pay for the product (215) before the printing device (103, FIG. 1) and the cutting device (105, FIG. 1) are activated.

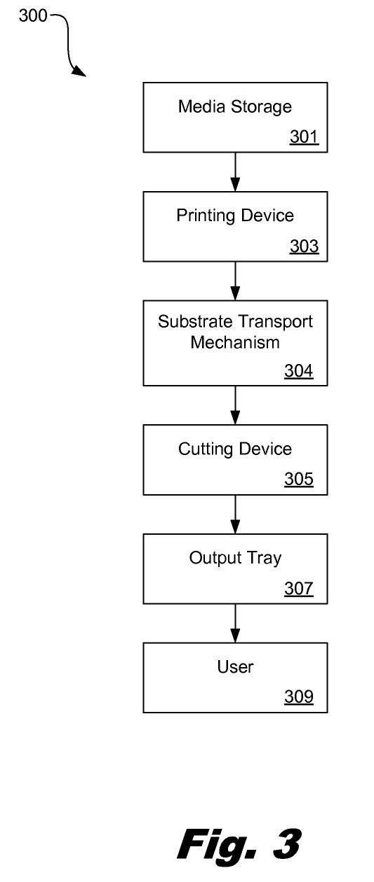

Referring now to FIG. 3, an illustrative substrate path (300) in a system of customized printing and cutting of a polymer substrate is shown. The substrate may begin in media storage (301). In embodiments using a continuous web of polymer substrate, the media storage (301) may be a roll. In embodiments using individual sheets of polymer substrate, the media storage (301) may be a tray.

The substrate may be transported from the media storage (301) to the printing device (303) according to the amount of substrate needed for a particular user's selected image and cutting pattern. The user-selected image may then be printed to the substrate by the printing device (303), after which the substrate may be transported to the cutting device (305).

A substrate transport mechanism (304) may be used to transport the substrate along its path between the printing device (303) and the cutting device (305). Such substrate transport mechanisms are well-known in the art and may include motorized rollers, belts, and/or any other suitable media transport devices suitable for a particular application of the principles of the present specification.

The cutting device (305) may selectively cut the substrate according to the cutting pattern selected by the user. The system may then transport the substrate to an output tray (307), where the newly printed and cut substrate may be retrieved by a user (309).

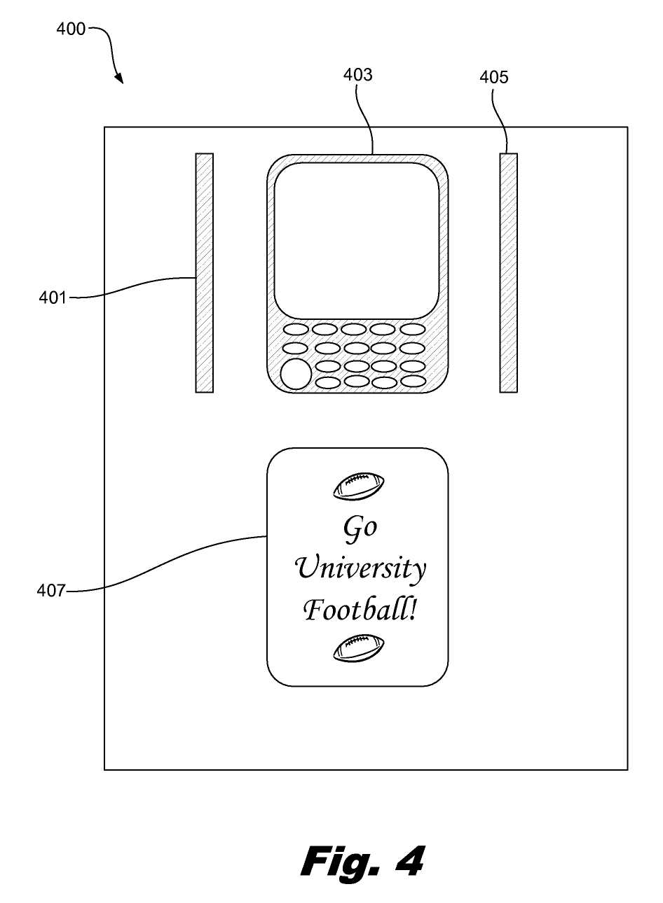

Referring now to FIG. 4, an illustrative sheet of polymer substrate (400) is shown after undergoing customized printing and cutting operations according to the principles described above. In the example shown, a system of customized printing and cutting was used to create a vinyl protective covering for a PDA.

The protective covering of the present example includes four pieces (401, 403, 405, 407) individually cut from a polymer substrate (400). The substrate (400) may be a sheet or part of a continuous roll of material.

In some embodiments, substrate (400) may include a paper or other backing to hold all of the pieces (401, 403, 405, 407) in place until removed from the backing. In some embodiments, an adhesive may be applied on the side of the substrate (400) which is covered by the backing paper until the cut-out is applied.

In other embodiments, the cutting device (105, FIG. 1) may dispense only the cut pieces (401, 403, 405, 407) to the user and discard unused portions of the substrate (400). As shown, different pieces (401, 403, 405, 407) may take on different appearances, according to the imaging preferences of the individual user.

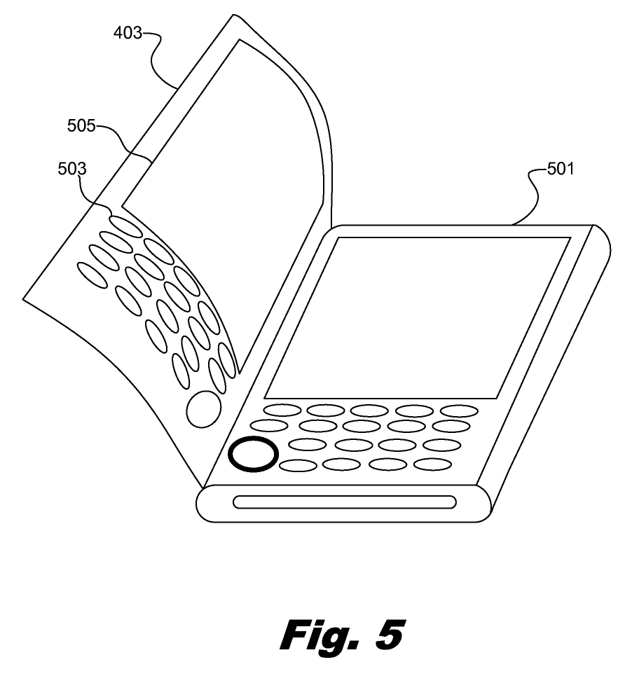

Referring now to FIG. 5, one of the vinyl pieces (403) of the protective covering of FIG. 4 is shown being applied to a personal electronic device (501). The vinyl piece (403) may include cutout portions (503, 505) corresponding to buttons and other features of the personal electronic device (501). As indicated above, the vinyl piece (403) may be applied to the personal electronic device (501) using static electricity. In other embodiments, the vinyl piece (403) may have at least one layer of adhesive material that facilitates sticking the vinyl piece (403) to the personal electronic device (501). Once applied, the personal electronic device may be protected from incidental scratches on the surface protected by the vinyl piece (403), in addition to taking on a customized appearance selected by the user.

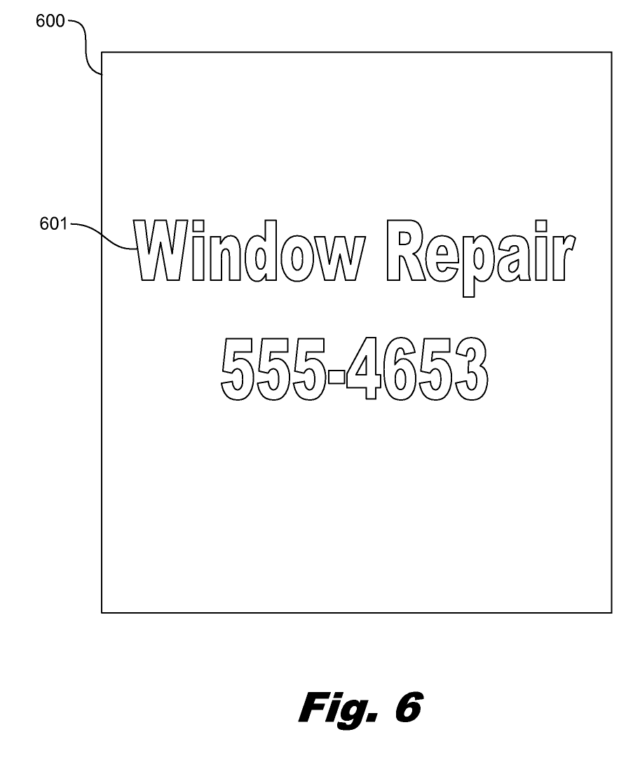

Referring now to FIG. 6, another illustrative sheet of polymer substrate (600) is shown after undergoing customized printing and cutting operations according to the principles described above. In the present example, the system was used to create individual vinyl characters (601) that may be applied using static electricity and/or other means (e.g. adhesives) to surfaces for signage.

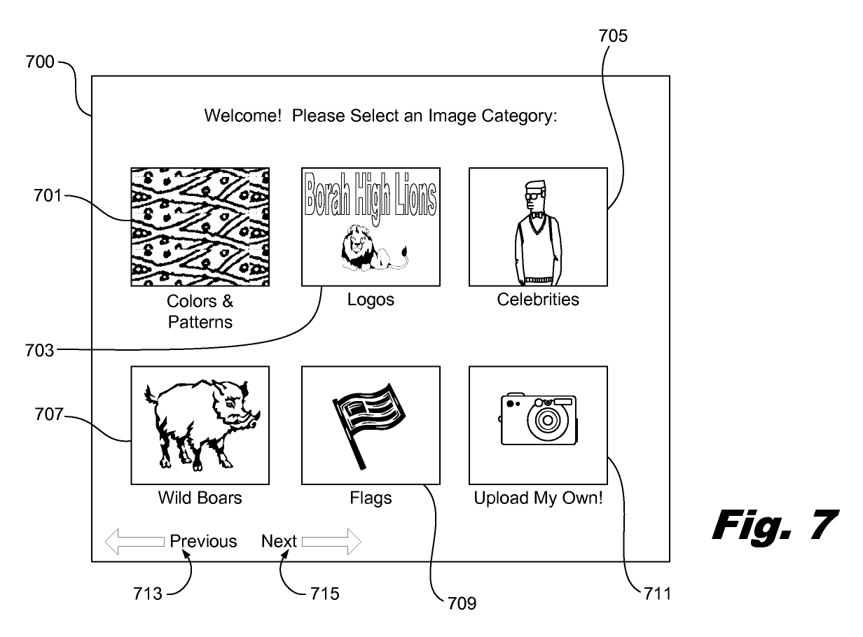

FIG. 7 illustrates one possible device that might be used as part of the user interface (101, FIG. 1) for communicating with the user of the system described herein. The illustrative screen shot of FIG. 7 is a prompt to a user to select, for example, an image for printing on a desired cut-out. The prompt is shown on a screen (700) of the user interface (101, FIG. 1). In the present example, the screen (700) may be a touch screen that may receive input from the user when the user touches a portion of the screen associated with a specific menu item or other selection.

Using the screen (700), the central processing element (107, FIG. 1) may be configured to run software that guides the user through a series of prompts, such as the illustrative prompt shown, that allow the user to select an image and a cutting template for use in creating the finished product. Navigational controls (713, 715) may also be provided in some embodiments to assist the user to move forward or backward through interactive menus.

In the illustrated example, the user is being prompted to select a category of image to be printed on the polymer substrate. The user may select from categories (701, 703, 705, 707, 709) of images stored by or accessible to the central processing element (107, FIG. 1) or select an option (711) allowing the user to upload his or her own image.

By selecting one of the categories (701, 703, 705, 707, 709) of images stored by or accessible to the central processing element, the user may then be able to view and select from images classified in that particular category to be printed to the substrate. By selecting the option (711) of uploading his or her own image, the user may then be given instructions for uploading an image to the system using a personal electronic device, portable storage media, and/or an internet website.

In certain embodiments, the user may select more than one image to be printed to the substrate. For example, a user may select a combination of a stock image stored by the central processing element (107, FIG. 1) and an uploaded personal image. In cases where more than one image is selected to be printed to the substrate, the software run by the central processing element (107, FIG. 1) may be configured to allow the user to arrange the relative placement of the images on the substrate through the touch screen (700). In some cases, the images may overlap.

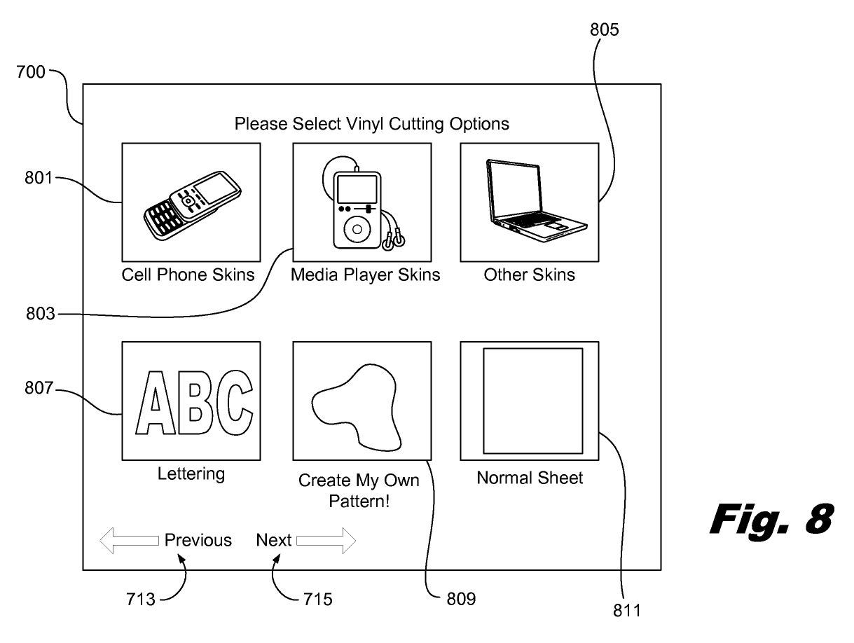

Referring now to FIG. 8, another illustrative user prompt is shown on the screen (700) in which the user is instructed to select a category of cutting pattern for the polymer substrate. In the present example, the user has the option to select from categories (801, 803, 805) of protective layers (“skins”) for personal electronic devices, a custom lettering category (807), a personalized cutting pattern option (809), and an option (811) for not using a cutting pattern at all.

In cases where the user selects one of the categories (801, 803, 805) dealing with cutting patterns for the portable device protective coverings, the user may be directed on a next screen to select from a list of specific personal electronic devices for which protective layer cutting templates are already available. The system may be configured to receive periodic updates of cutting templates from a server to ensure that the majority of personal electronic devices likely to be owned by users of the system are available to the system.

In certain embodiments where the system does not have a cutting pattern template for a protective layer of a particular device stored locally, the central processing element (107, FIG. 1) of the system may be configured to check with a remote computing device, such as a server, through a network connection for the requested or an appropriate template. In other embodiments, users may interactively request that cutting patterns for specific devices be made available on the system. These requests may then be logged and monitored periodically by owners or purveyors of the system to gauge what updates to the templates may best serve the needs of the users of the system.

Furthermore, the user may be allowed to further customize a cutting pattern corresponding to a protective covering for a specific personal electronic device by specifying additional cutouts or otherwise altering the cutting pattern. As indicated above, the user interface (101, FIG. 1) will except user input specifying such modifications to an existing cutting pattern.

When any of the options shown in FIG. 8 are selected, the user will receive additional prompts as needed to ascertain the user's desires for the customized product. For example, in cases where the user selects the lettering category (807), the user may be directed to one or more screens that allow the user to select the type of lettering (size, font, thickness, etc.) of the lettering and input the desired characters to create a cutting pattern that meets his or her needs. In cases where the user selects the personalized cutting pattern category (809), the user may be directed to one or more screens that allow the user to create his or her cutting pattern using interactive software tools.

In cases where the user elects the option (811) of not using a cutting pattern at all, the desired image may be printed on the polymer substrate and delivered to the user as a sheet. On occasion, a user may wish to cut the printed substrate manually (e.g. for scrapbooking or for an unsupported product). In some embodiments, a vinyl cutting tool may be purchased and dispensed from the system as a convenience to these users.

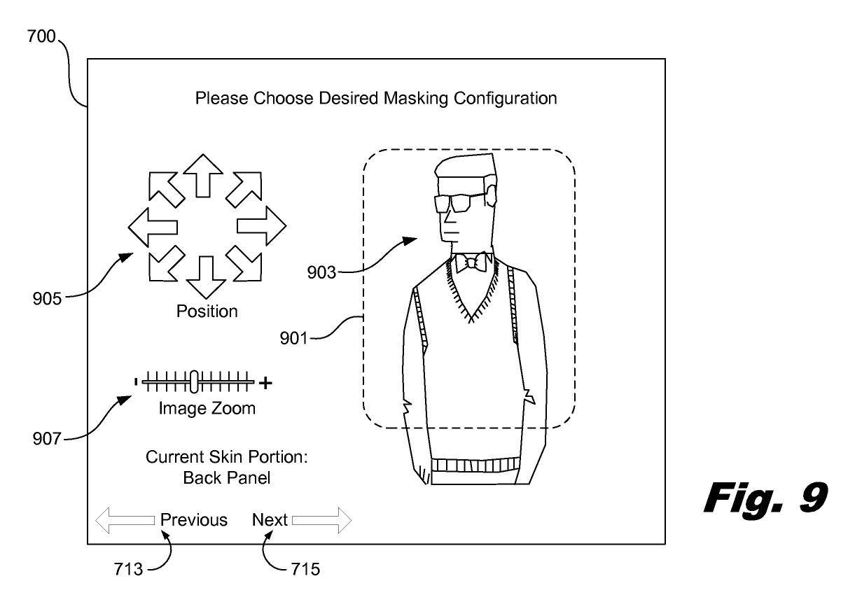

Referring now to FIG. 9, another illustrative prompt is shown on the screen (700) in which the user is requested to choose a desired orientation and size of the selected cutting pattern (901) with respect to the selected image (903). Interactive software tools (905, 907) may aid the user in adjusting specific aspects of the relationship between the selected cutting pattern (901) and the selected image (903), such as the relative position of the image (903) and the relative size of the image (903) with respect to the cutting pattern (901). In some embodiments, the cutting pattern (901) may include a plurality of parts, and the relationship between the selected image(s) and each portion of the cutting pattern (901) may be determined separately.

Once a user has selected one or more images, a cutting pattern, and has oriented the image with respect to the cutting pattern, the user may be directed to a screen that allows the user to purchase the final product by submitting payment information as described herein. The system may then print the desired image on the polymer substrate and cut the desired pattern into the printed substrate, after which the newly printed and cut vinyl substrate may be dispensed to the user.

### Illustrative Method

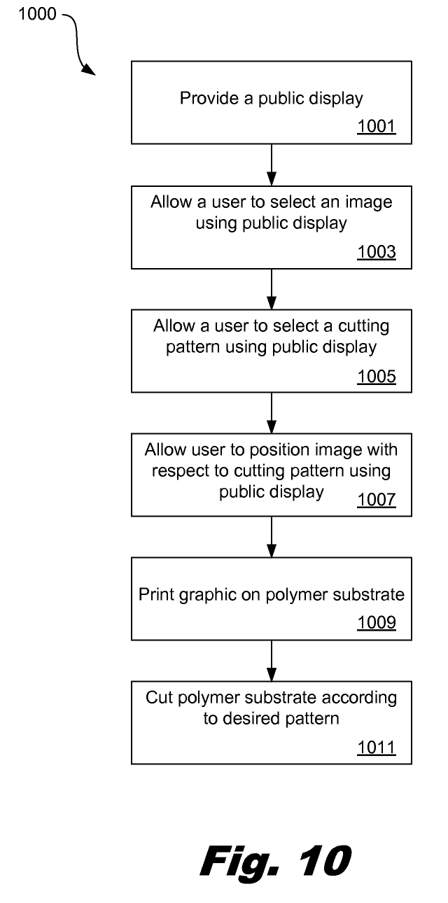

Referring now to FIG. 10, an illustrative method (1000) of customized printing and cutting of a polymer substrate is shown. The method (1000) includes providing a public display (step 1001), such as a kiosk located in a place frequently trafficked by pedestrians. A user may then be allowed to select an image (step 1003) using the display. The image may be stored locally or remotely and accessible to a central processing element and/or uploaded by the user.

After the user has selected an image (step 1003), the user may be allowed to select a desired cutting pattern (step 1005) through the public display and position the graphic (step 1007) with respect to the cutting pattern according to a desired configuration. In certain embodiments, the cutting pattern may be a pattern for a protective covering to a personal electronic device or other object. In other embodiments, the cutting pattern may correspond to desired lettering, logos, trademarks, or other custom images desired by a user.

The desired graphic may then be printed onto the polymer substrate (step 1009), after which the polymer substrate may be cut (step 1011) according to the desired cutting pattern. In certain embodiments, payment may be collected from the user prior to printing and cutting the polymer substrate. After the substrate has been printed and cut, it may be dispensed to the user.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system, comprising:
an interactive user interface configured to receive image and cutting pattern selections from a user;
a printing device configured to print said image selection to a polymer substrate; and
a cutting device configured to cut said polymer substrate according to said cutting pattern selection.

2. The system of claim 1, further comprising a central processing element communicatively coupled to said interactive user interface, said printing device, and said cutting device.

3. The system of claim 2, wherein said central processing element is configured to store a plurality of images and cutting patterns and make said images and cutting patterns available to said user through said interactive user interface.

4. The system of claim 2, wherein at least one of said image selection and said cutting pattern selection is uploaded by said user to said central processing element.

5. The system of claim 1, wherein said system is located in a public place.

6. The system of claim 1, wherein said cutting selection corresponds to a protective covering for a personal electronic device.

7. The system of claim 1, wherein said interactive user interface is further configured to receive payment from said user.

8. The system of claim 1, further comprising a substrate transport mechanism configured to transport said substrate from said printing device to said cutting device.

9. A system, comprising:
an interactive user interface configured to receive image and cutting pattern selections from a user;
a printing device configured to print said image selection to a polymer substrate;
a cutting device configured to cut said polymer substrate according to said cutting pattern selection; and
a central processing element communicatively coupled to said user interface, said printing device, and said cutting device; and
a remote computing device communicatively coupled to said central processing element through a network.

10. The system of claim 9, wherein said central processing element is configured to store a plurality of images and cutting patterns and make said images and cutting patterns available to said user through said interactive user interface.

11. The system of claim 10, wherein said remote computing device is configured to periodically update said stored images and cutting patterns.

12. The system of claim 9, wherein at least one of said image selection and said cutting pattern selection is uploaded by said user to said central processing element.

13. The system of claim 9, wherein said system is located in a public place.

14. The system of claim 9, wherein said cutting selection corresponds to a protective covering for a personal electronic device.

15. The system of claim 9, wherein said interactive user interface is further configured to receive payment from said user.

16. The system of claim 15, wherein said remote computing device is configured to verify credit information from said user.

17. The system of claim 9, further comprising a substrate transport mechanism configured to transport said substrate from said printing device to said cutting device.

18. A method, comprising:
electronically receiving user input designating a selected image and cutting pattern using a kiosk;
printing said selected image on a polymer substrate at said kiosk; and
cutting said substrate according to said selected cutting pattern at said kiosk.

19. The method of claim 18, further comprising allowing said user to select a desired position of said image with respect to said cutting pattern.

20. The method of claim 18, further comprising dispensing said substrate to said user at said kiosk.
